(19) United States
(12) Patent Application Publication
(10) Pub. No.: US 2013/0061999 A1
(43) Pub. Date: Mar. 14, 2013

(54) METHOD FOR INSTALLATION OF STATIC-CONTROL FLOORING MATERIALS

(71) Applicant: Thomas E. Ricciardelli, Hingham, MA (US)

(72) Inventor: Thomas E. Ricciardelli, Hingham, MA (US)

(21) Appl. No.: 13/571,669

(22) Filed: Aug. 10, 2012

Related U.S. Application Data
(60) Provisional application No. 61/522,293, filed on Aug. 11, 2011.

(51) Int. Cl. B32B 37/12

(52) U.S. Cl. CPC B32B 37/1292
USPC 156/60; 427/58

(57) ABSTRACT

A method of installing static-control carpet tiles on top of metal access floor panels that are grounded. A “dab” of conductive adhesive, which is between approximately 0.25 and 2.0 inches in diameter and approximately between 0.05 and 0.5 inches thick provides an electrical connection between the carpet tile and the metal access floor panel, which in turn is connected to an earth ground. Static electrical charges can then travel through the carpet tile to the access floor panel and then to ground.

### PRIORITY DATA

This application claims the benefit of previously filed provisional application Ser. No. 61/522,293 filed Aug. 11, 2011, the entirety of which is hereby incorporated by reference

### BACKGROUND OF THE INVENTION

1. Field of the Invention

The present invention relates to a method for installing static control flooring materials. More particularly, it relates to a method for installing static-control carpet tiles on top of metal access floor panels that are grounded.

2. Description of Related Art

Conventional installation of static-control flooring materials generally requires the use of conductive adhesives to provide an electrical connection between the individual tiles and provide an electrical path for the static charges to travel to an earth ground. In effect, static charges travel from the person, through the floor tile and from tile to tile until the static charges reach an installed earth ground. The use of these adhesives is generally messy, time-consuming and adds to the cost and complexity of an installation. An example of a conventional installation is shown in FIGS. 1A-1F.

Shown in FIG. 1A, a roll of adhesive strips includes a continuous strip of material that may be dispensed. FIG. 1B shows that an exposed portion of the roll can release a desired portion, for example, a length of approximately two inches of the adhesive strip material. FIG. 1C shows that the dispensed length of adhesive material is placed “sticky-side-up” (i.e., the adhesive surface used to connect the carpet tiles that are being installed). FIG. 1D shows that the carpet tile is mounted onto the dispensed adhesive strip material so that the carpet tile adheres to the dispensed adhesive strip material. FIG. 1E shows a perspective view of carpet tiles installed using the adhesive strip material. Each corner of the carpet tile is adhered to a part of an adhesive strip such that the carpet tiles are connected. FIG. 1F shows a view of a carpet tile being mounted on an adhesive strip to fit in an abutting relationship with three other carpet tiles.

Unfortunately, when carpet tiles are mounted on a metal, or conductive, floor panel, the method illustrated in FIGS. 1A-1F does not provide an adequate electrical connection to provide a conductive path from the floor to an “earth ground” (electrical ground) to thereby dissipate the electricity.

### SUMMARY OF THE INVENTION

The present invention relates to alternative installation method of flooring material, such as static-control carpet tiles on top of a surface, such as metal access floor panels that are grounded. In the technique of the present invention, a very small dab of conductive adhesive (between approximately 0.25 and 2.0 inches in diameter and approximately between 0.05 and 0.5 inches thick) provides an electrical connection between the carpet tile and the metal access floor panel, which in turn is connected to an earth ground (electrical ground). Static electrical charges can then travel through the carpet tile to the access floor panel and then to ground.

One embodiment of the present invention is directed to a method in which carpet tiles are mounted to a sub-floor using a conductive adhesive material. A plurality of application amounts of conductive adhesive material, each amount approximately between 0.5-1.5 inches in diameter an approximately between 0.3 inches thick, is applied to various sections of either the mounting surface (i.e., floor or sub-floor, or surface the carpet tiles are to be mounted) or the lower surface of the carpet tile (the lower surface being the carpet tile surface that interfaces with the surface the carpet tile is being mounted on). The conductive adhesive material provides an electrical connection between the carpet tile and the metal access floor panel, which in turn is connected to an earth ground. Static electrical charges can then travel through the carpet tile to the access floor panel and then to ground.

Another embodiment of the present invention is directed to a method that includes providing one or more conductive adhesive dabs on a surface; and mounting a material that adheres to at least one of the one or more conductive adhesive dabs. Thus, an electrically conductive path is formed from the material to the surface via one or more of the conductive adhesive dabs.

Yet another embodiment of the present invention is to store or place a liquid form of the conductive adhesive material in an aerosol dispensing can so as to enable a user to apply the adhesive material to a surface by “spraying” the conductive adhesive spray on the surface, of either the floor and/or tile, similar to applying spray paint.

### BRIEF DESCRIPTION OF THE DRAWINGS

FIGS. 1A-F is an example of a conventional technique to install carpet tiles.

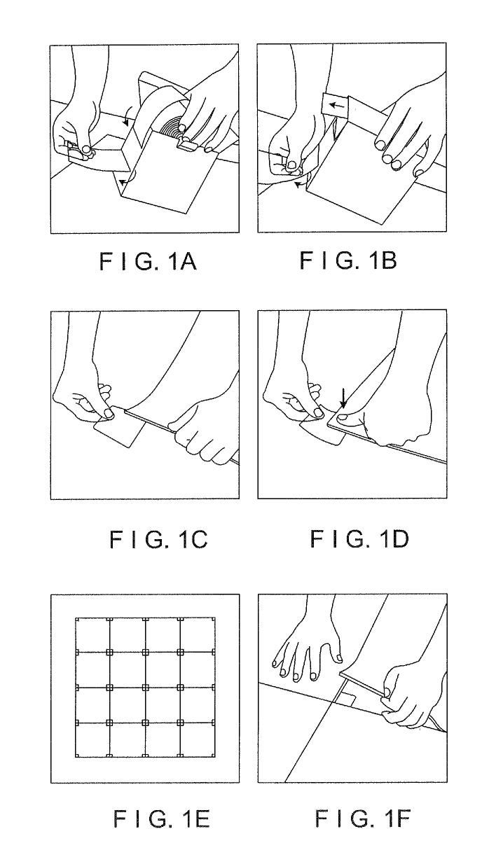

FIG. 2 shows three carpet tiles connected with an adhesive material.

FIG. 3 shows a metal access floor with three carpet tiles mounted on an upper surface of the metal access floor.

FIG. 4 shows a metal sub-floor surface with a plurality of conductive adhesive spots thereon.

FIG. 5 shows a carpet tile being installed according to the present invention.

FIG. 6 shows an embodiment of the present invention in which the conductive adhesive material is produced in a form suitable to be applied as a spray from an aerosol container.

### DETAILED DESCRIPTION

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments. One embodiment of this invention provides for an alternative installation method of static-control carpet tiles when installed on top of metal access floor panels that are grounded. In one example, a very small “dab” (a “dab” being between approximately 0.25 and 3.5 inches in diameter and approximately between 0.05 and 1.0 inches thick) of conductive adhesive provides an electrical connection between the carpet tile and the metal access floor panel, which in turn is connected to an earth ground. Other sizes of dabs may also be suitably used, either larger or smaller depending on the material to be mounted, sub-floor material and other application specifications. Static electrical charges can then travel through the carpet tile to the access floor panel and then to ground, via the dabs. The dab of adhesive provides an electrical connection with the metal panel. Carpet tiles laid directly on the metal panel do not have a strong enough connection to provide a secure electrical connection. The dab of adhesive provides a “wetted” connection between the two materials (carpet tile and metal panel).

To facilitate installation, the metal access panels should be clean and either unpainted or painted with conductive paint to allow an electrical connection between the tile and the panel. Conductive adhesive with a resistivity rating of between approximately 2.5×10⁴ and 1.0×10⁶ may be used for installation. A dab of adhesive, of approximately 1 inch in diameter is applied to either the back of the carpet tile or on the metal panel. The tile is then laid in place, as needed for the flooring installation. More dabs of adhesive and larger dabs of adhesives, can be used if desired. Additional tiles are then laid into place, butting against adjacent tiles, each using at least one dab of adhesive, which is at least 1 inch in diameter.

For a more stable installation, tiles can be secured to one another using connector tabs, such as Tactiles™ from Interface Floor™, carpet tape, or duct tape. These connectors are not required for the electrical performance of the flooring, only to secure the tiles to one another for a more stable installation.

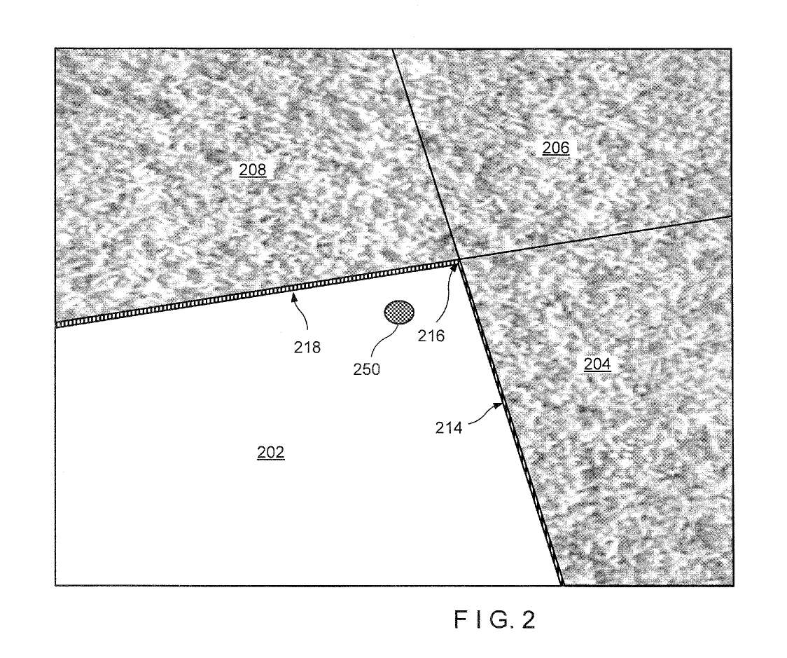

FIG. 2 shows three carpet tiles 204, 206 and 208 connected with an adhesive material (not shown). Each carpet tile 204, 206 and 208 has an exposed edge 214, 216 and 218, respectively. An upper surface 202 of a metal sub-floor is exposed and includes an adhesive material 250 that will adhere to a fourth carpet tile so that the edges of a fourth carpet tile (not shown) will abut surfaces 214, 216 and 218.

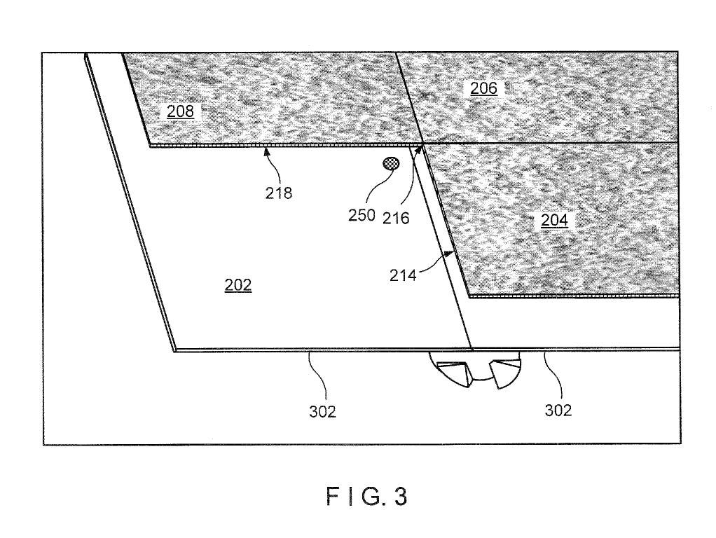

FIG. 3 shows a metal access floor 302 (having upper surface 202) with three carpet tiles 204, 206 and 208 mounted on upper surface 202 of the metal access floor panel 302. The adhesive material 250 as well as edges 214, 216 and 218 are also shown.

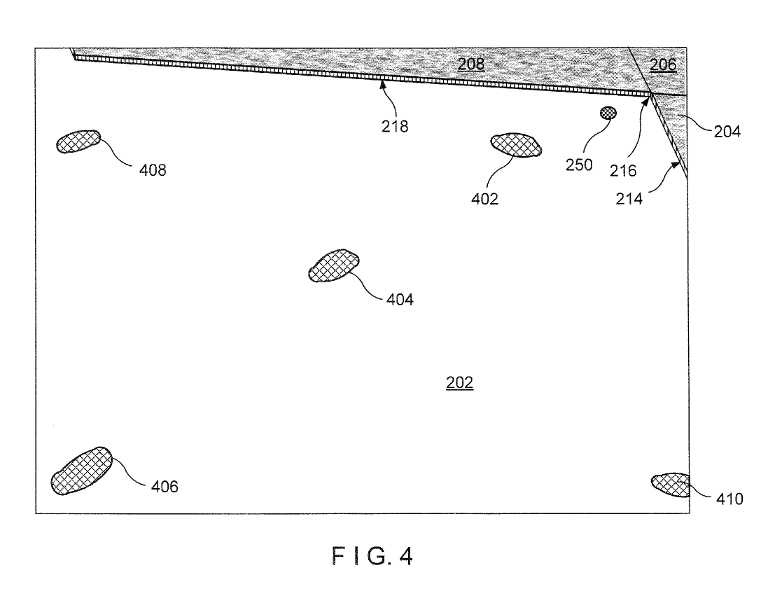

FIG. 4 shows a metal sub-floor surface 202 with a plurality of conductive adhesive dabs 402, 404, 406, 408 and 410 (partial) thereon. Each dab 402, 404, 406, 408 and 410 is approximately between 1.0 and 1.5 inches wide and approximately between 0.1 and 0.2 inches high. The carpet tile is then laid in place on the metal sub-floor 202 for the flooring installation. More dabs of adhesive and larger dabs of adhesives can be used if desired. Additional tiles are then laid into place, butting against adjacent tiles, each using at least one or more dabs of adhesive. The conductive dabs 402, 404, 406, 408 and 410 are used to provide an electrical connection with the metal panel 302.

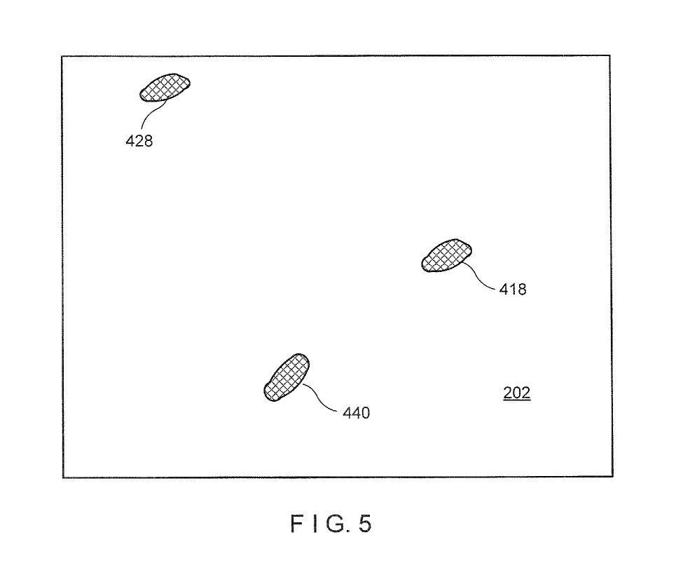

FIG. 5 shows a carpet tile being installed according to the present invention. The carpet tile is to be mounted on surface 202 and contact conductive adhesive dabs 418, 428 and 440. Thus an electrically conductive path is established between the carpet tile and a ground (not shown).

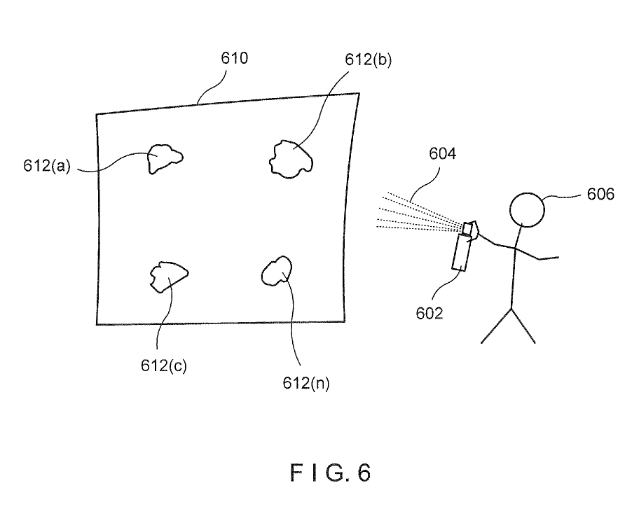

FIG. 6 shows a user, or technician 606 applying the conductive adhesive material, as described herein, from an aerosol container 602, such that the conductive adhesive material is applied to a surface 610, as a spray 604. The spray may be applied as conductive/adhesive spots or dabs 612(a) . . . (n) (where “n” is any suitable number). Thus, the user may apply the adhesive conductive material in “spray dabs” generally shown as 612. The user 606 can use the spray embodiment to spray discrete areas of the floor and/or tile. Thus, it may not be necessary to apply an entire “coat” of the conductive adhesive material. Indeed, intermittent spray dabs may often be adequate to cause the tile to adhere to the floor and provide the desired conductive properties between the floor tile and floor surface.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. A variety of modifications to the embodiments described will be apparent to those skilled in the art from the disclosure provided herein. Thus, the present invention may be embodied in other specific forms without departing from the spirit or essential attributes thereof. Various changes may be made without departing from the spirit and scope of the inventions as defined in the following claims.

What is claimed is:

1. A method comprising:
providing one or more conductive adhesive dabs on a surface; and
mounting a material that adheres to at least one of the one or more conductive adhesive dabs,
wherein an electrically conductive path is formed from the material to the surface via one or more of the conductive adhesive dabs.

2. A method comprising:
providing a conductive adhesive material in a form suitable for application by an aerosol container; and
applying the conductive adhesive material to a surface.
